(19) United States
(12) Patent Application Publication
(10) Pub. No.: US 2025/0306172 A1
(43) Pub. Date: Oct. 2, 2025

(54) SENSING DEVICE, SENSING METHOD, AND RECORDING MEDIUM

(71) Applicant: Panasonic Intellectual Property Management Co., Ltd., Osaka (JP)

(72) Inventors: Nobuyuki SHIRAKI, Hokkaido (JP); Takeshi NAKAYAMA, Hyogo (JP); Shoichi IIZUKA, Osaka (JP); Naoki HONMA, Iwate (JP)

(21) Appl. No.: 19/090,804

(22) Filed: Mar. 26, 2025

(30) Foreign Application Priority Data
Mar. 28, 2024 (JP) 2024-054698

(51) Int. Cl. G01S 7/41; G01S 7/295

(52) U.S. Cl. CPC G01S 7/415; G01S 7/295

(57) ABSTRACT

A sensing device includes: an obtainer that obtains a radio information item obtained by at least one of: a first radio disposed in a target space and capable of at least wireless transmission; or a second radio disposed in the target space and capable of at least wireless reception; a determiner that determines, based on the radio information item, whether a movable radio out of the first radio and the second radio is stationary; and a sensing portion that (i) performs sensing of a living body in the target space using a channel state information (CSI) item when the determiner determines that the movable radio is stationary, where the CSI item is included in the radio information item and received from the first radio by the second radio, and (ii) does not perform the sensing when the determiner determines that the movable radio is moving.

### CROSS REFERENCE TO RELATED APPLICATION

The present application is based on and claims priority of Japanese Patent Application No. 2024-054698 filed on Mar. 28, 2024. The entire disclosure of the above-identified application, including the specification, drawings and claims is incorporated herein by reference in its entirety.

### FIELD

The present disclosure relates to a sensing device, a sensing method, and a recording medium for accurately performing sensing of a living body.

### BACKGROUND

A method that uses radio signals is being considered as a method for knowing the position of a person. For example, PTL 1 discloses techniques of estimating the position and state of a person that is a detection target by analyzing a component including a Doppler shift using difference calculation.

### CITATION LIST

### Patent Literature

PTL 1: Japanese Unexamined Patent Application Publication No. 2015-117972

### SUMMARY

With a conventional method, it is difficult to more accurately perform sensing of a living body.

In view of the above situations, the present disclosure provides, for instance, a sensing device capable of more accurately performing sensing of a living body.

A sensing device according to one aspect of the present disclosure includes: an obtainer that obtains a radio information item obtained by at least one of: a first radio disposed in a target space and capable of at least wireless transmission; or a second radio disposed in the target space and capable of at least wireless reception; a determiner that determines, based on the radio information item, whether a movable radio out of the first radio and the second radio is stationary; and a sensing portion that (i) performs sensing of a living body in the target space using a channel state information (CSI) item when the determiner determines that the movable radio is stationary, where the CSI item is included in the radio information item and received from the first radio by the second radio, and (ii) does not perform the sensing when the determiner determines that the movable radio is moving.

A sensing method according to one aspect of the present disclosure is to be executed by a sensing device, and includes: obtaining a radio information item obtained by at least one of: a first radio disposed in a target space and capable of at least wireless transmission; or a second radio disposed in the target space and capable of at least wireless reception; determining, based on the radio information item, whether a movable radio out of the first radio and the second radio is stationary; and performing sensing of a living body in the target space using a channel state information (CSI) item when it is determined that the movable radio is stationary in the determining, where the CSI item is included in the radio information item and received from the first radio by the second radio, and not performing the sensing when it is determined that the movable radio is moving in the determining.

It should be noted that these general or specific aspects may be implemented by a system, an integrated circuit, a computer program, or a computer-readable recording medium such as a CD-ROM, or any combination of an apparatus, a system, a method, an integrated circuit, a computer program, or a recording medium.

With the sensing device and so on according to the present disclosure, it is possible to more accurately perform sensing of a living body.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for illustrating an overview of a sensing system according to Embodiment 1.

FIG. 2 is a diagram illustrating one example of the configuration of the sensing system according to Embodiment 1.

FIG. 3 is a diagram for illustrating the relationship of a transmission signal, a channel, and a reception signal.

FIG. 4 is a diagram for illustrating propagation characteristics at each timing.

FIG. 5 is a flowchart illustrating one example of a sensing method to be performed by a sensing device according to Embodiment 1.

FIG. 6 is a diagram illustrating one example of the configuration of a sensing system according to Embodiment 2.

FIG. 7 is a diagram for illustrating propagation characteristics at each timing.

FIG. 8 is a diagram illustrating the experiment results of evaluation values for estimating whether a radio is stationary based on CSI.

### DESCRIPTION OF EMBODIMENTS

### (Underlying Knowledge Forming Basis of the Present Disclosure)

A method that uses radio signals is being considered as a method for sensing a living body.

With the conventional techniques as disclosed in PTL 1, a transmission device that transmits a radio signal and a reception device that receives the radio signal are fixed, and a case where at least one of the transmission device or the reception device moves is not taken into consideration. When at least one of the transmission device or the reception device moves and the position of the device changes, it is difficult to accurately perform sensing of a living body since the radio signal is affected depending on the position change.

In view of this, the inventors have come to discover a sensing device capable of accurately performing sensing of a living body.

A sensing device according to a first aspect of the present disclosure includes: an obtainer that obtains a radio information item obtained by at least one of: a first radio disposed in a target space and capable of at least wireless transmission; or a second radio disposed in the target space and capable of at least wireless reception; a determiner that determines, based on the radio information item, whether a movable radio out of the first radio and the second radio is stationary; and a sensing portion that (i) performs sensing of a living body in the target space using a channel state information (CSI) item when the determiner determines that the movable radio is stationary, where the CSI item is included in the radio information item and received from the first radio by the second radio, and (ii) does not perform the sensing when the determiner determines that the movable radio is moving.

According to this, since sensing is performed in a target space using CSI when a movable radio is stationary, there is no need to take an influence caused by the movement of the movable radio into consideration, and therefore, sensing of a living body can be accurately performed.

A sensing device according to a second aspect of the present disclosure is the sensing device according to the first aspect, and the radio information item also includes sensing information obtained by at least one of an acceleration sensor, an angular rate sensor, or a global positioning system (GPS) sensor included in the movable radio, and the determiner determines whether the movable radio is stationary based on the sensing information.

According to this, whether a movable radio is stationary is determined based on sensing information obtained by at least one of an acceleration sensor, an angular rate sensor, or a GPS sensor. It is therefore possible to accurately determine whether the movable radio is stationary.

A sensing device according to a third aspect of the present disclosure is the sensing device according to the first aspect or the second aspect, and further includes a storage that stores radio information items obtained over a given period, the radio information items each being the radio information item. The determiner determines whether the movable radio is stationary, using an evaluation value calculated from index values based on CSI items included in the radio information items. Each of the index values is an index value of a specific index of a CSI item, among the CSI items, corresponding to the index value.

According to this, since whether a movable radio is stationary is determined based on CSI items stored over a given period, even a radio without a sensor capable of detecting that the movable radio is moving can determine whether the movable radio is stationary.

A sensing device according to a fourth aspect of the present disclosure is the sensing device according to the third aspect, and the specific index includes an absolute value of the CSI item.

A sensing device according to a fifth aspect of the present disclosure is the sensing device according to the third aspect or the fourth aspect, and the specific index includes a phase of the CSI item.

A sensing device according to a sixth aspect of the present disclosure is the sensing device according to any one of the third aspect to the fifth aspect, and the specific index includes a correlation matrix of the CSI item.

A sensing device according to a seventh aspect of the present disclosure is the sensing device according to any one of the third aspect to the sixth aspect, and the evaluation value includes variance or covariance of the index values.

A sensing device according to an eighth aspect of the present disclosure is the sensing device according to any one of the third aspect to the sixth aspect, and the evaluation value includes (i) at least one of a mean, a median, a mode, a maximum value, or a minimum value of the index values, or (ii) at least one of a mean, a median, a mode, a maximum value, or a minimum value of variance or covariance of the index values.

A sensing method according to a ninth aspect of the present disclosure is to be executed by a sensing device, and includes: obtaining a radio information item obtained by at least one of: a first radio disposed in a target space and capable of at least wireless transmission; or a second radio disposed in the target space and capable of at least wireless reception; determining, based on the radio information item, whether a movable radio out of the first radio and the second radio is stationary; and performing sensing of a living body in the target space using a channel state information (CSI) item when it is determined that the movable radio is stationary in the determining, where the CSI item is included in the radio information item and received from the first radio by the second radio, and not performing the sensing when it is determined that the movable radio is moving in the determining.

According to this, sensing is performed in a target space using CSI while a movable radio is stationary, there is no need to take an influence caused by the movement of the movable radio into consideration. It is therefore possible to accurately perform sensing of a living body.

A recording medium according to a tenth aspect of the present disclosure is for use in a computer, the recording medium having recorded thereon a computer program for causing the computer to execute the sensing method according to the ninth aspect of the present disclosure.

It should be noted that the present disclosure can be implemented not only as a device, but also as an integrated circuit that includes processing means included in such a device, or as a method including, as steps, processes performed by the processing means included in the device, or as a program causing a computer to execute the steps, or as information, data, or a signal indicating the program. The program, information, data, and signal may be distributed via a recording medium such as a CD-ROM or a communication medium such as the Internet.

Hereinafter, embodiments of the present disclosure will be described with reference to the drawings. It should be noted that the embodiments described below each show a preferred and specific example of the present disclosure. The numerical values, shapes, materials, elements, the arrangement and connection of the elements, steps, orders of steps, etc., shown in the following embodiments are mere examples, and are not intended to limit the present disclosure. Moreover, among the elements in the following embodiments, those not recited in any of the independent claims reciting the broadest concept of the present disclosure are described as optional elements included in a more preferred embodiment. Elements that are essentially same share like reference signs in the Description and the drawings to omit redundant descriptions.

### Embodiment 1

Embodiment 1 describes a method of determining whether wireless equipment is stationary, and sensing a living body when the wireless equipment is stationary in the case of employing a multiple-input multiple-output (MIMO) method in which the number of transmission antennas and the number of reception antennas are both plural. The method is likewise applicable to a single-input multiple-output (SIMO) method or a multiple-input single-output (MISO) method in which either the number of transmission antennas or the number of reception antennas is plural.

### [Configuration]

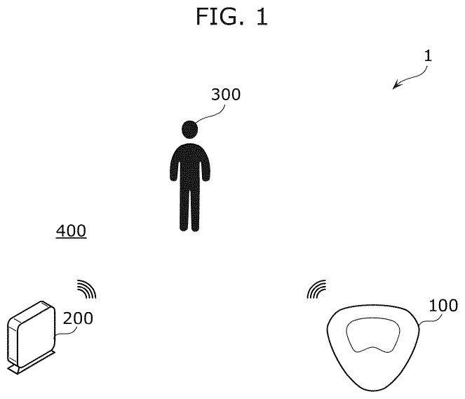

FIG. 1 is a diagram for illustrating an overview of a sensing system according to Embodiment 1.

Specifically, FIG. 1 illustrates first radio 100, sensing device 200, and living body 300. Among these, sensing system 1 includes first radio 100 and sensing device 200, for example. First radio 100 is a radio that is placed in target space 400 and is capable of at least wireless transmission. Target space 400 is a space in which sensing of living body 300 can be performed by first radio 100 and sensing device 200 and the sensing is to be performed. First radio 100 is a movable radio. First radio 100 is, for example, an autonomous vacuum cleaner. First radio 100 is not limited to an autonomous vacuum cleaner and may be a mobile terminal such as a smartphone. Sensing device 200 may have, for example, a wireless function for receiving a radio signal transmitted from first radio 100. Sensing device 200 is, for example, a router. Sensing device 200 is not limited to a router and may be a mobile terminal such as a smartphone.

In sensing system 1, first radio 100 transmits a radio signal to sensing device 200. When transmitting the radio signal, first radio 100 emits electric waves based on the radio signal in target space 400. The electric waves emitted in target space 400 are reflected by living body 300 in target space 400. Sensing device 200 receives electric waves including the electric waves reflected by living body 300, and performs sensing of living body 300 based on the received electric waves. The sensing of living body 300 includes detecting the position of living body 300 in target space 400, identifying living body 300, determining whether living body 300 is present in target space 400, identifying the movement of living body 300, and identifying the orientation of living body 300. In locating living body 300 in target space 400, the total distance of the distance between first radio 100 and living body 300 and the distance between living body 300 and second radio 201 may be calculated, or the direction (angle) of living body 300 relative to first radio 100 may be identified, or the direction (angle) of living body 300 relative to second radio 201 may be identified.

It should be noted that in the sensing of living body 300, a method such as a multiple signal classification (MUSIC) method, a beamformer method, or a Capon method, or a different method that is conventionally known may be used, or a sensor that achieves these functions may be provided in first radio 100 or sensing device 200.

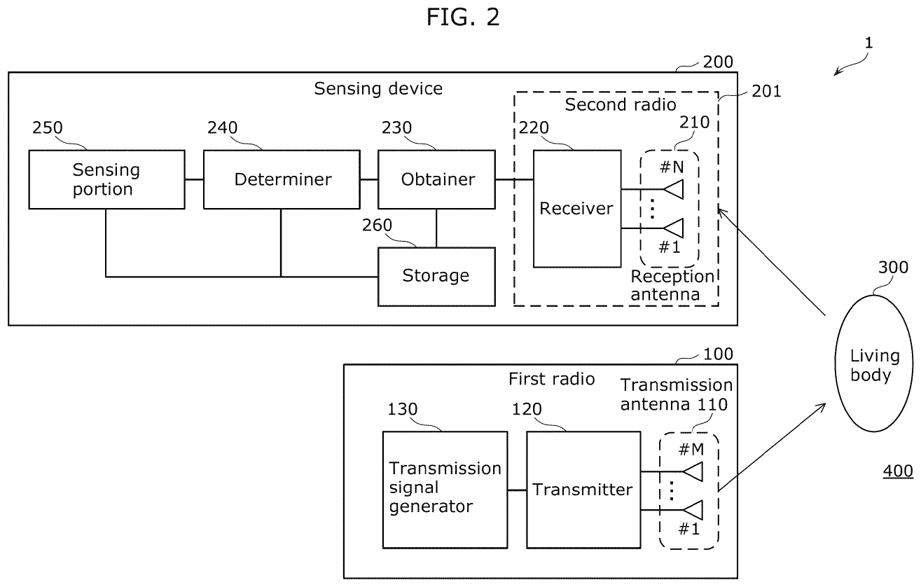

FIG. 2 is a diagram illustrating one example of the configuration of the sensing system according to Embodiment 1.

Sensing system 1 includes first radio 100 and sensing device 200.

First radio 100 includes transmission antenna 110, transmitter 120, and transmission signal generator 130.

Transmission antenna 110 has M transmission antenna elements. Here, M is a natural number greater than or equal to 1. The M transmission antenna elements each transmit a multicarrier signal (transmission wave) generated by transmitter 120 to be described later.

Transmission signal generator 130 generates a multicarrier signal into which subcarrier signals are modulated. Specifically, transmission signal generator 130 generates subcarrier signals corresponding to subcarriers in mutually different frequency bands, and generates a multicarrier signal by multiplexing the generated subcarrier signals. The present embodiment illustrates an example in which transmission signal generator 130 generates, as a multicarrier signal, an orthogonal frequency division multiplexing (OFDM) signal that has high frequency band utilization efficiency and includes S subcarriers. However, transmission signal generator 130 is not limited to generate an OFDM signal including subcarriers that are each orthogonal, and may generate other multicarrier signal such as a simple frequency division multiplexing (FDM) signal as long as the multicarrier signal is obtained through multicarrier modulation.

A signal generated by transmission signal generator 130 may be commonly used with a signal for use in communication.

Transmitter 120 additionally performs an appropriate process on a signal generated by transmission signal generator 130, and generates a transmission wave. The process performed here includes, for example, up-conversion of converting a signal from the frequency band of intermediate frequency (IF) to the frequency band of radio frequency (RF), and amplification of amplifying a signal to an appropriate transmission level. Transmitter 120 outputs a processed multicarrier signal to transmission antenna 110 to cause transmission antenna 110 to transmit the multicarrier signal. With this, the multicarrier signal is transmitted from the M transmission antenna elements included in transmission antenna 110.

Sensing device 200 includes reception antenna 210, receiver 220, obtainer 230, determiner 240, sensing portion 250, and storage 260. Among these, reception antenna 210 and receiver 220 function as second radio 201. In other words, it can be said that sensing device 200 includes second radio 201 in the present embodiment.

Reception antenna 210 has N reception antenna elements. Here, N is a natural number greater than or equal to 1. It should be noted that when one of M and N is 1, the other is greater than or equal to 2. The N reception antenna elements each receive a signal (reception signal) transmitted from the M transmission antenna elements and reflected by living body 300.

Receiver 220 measures, in a first period equivalent to a cycle derived from the activity of living body 300, a reception signal that is received by each of the N reception antenna elements and includes a reflected signal obtained as a result of living body 300 reflecting or scattering a multicarrier signal transmitted from the M transmission antenna elements. The cycle derived from the activity of living body 300 is a living body-derived cycle (a biological variable cycle), which is a time period greater than or equal to a half-cycle of any of the cycles of respiration, heartbeat, or body motion of living body 300. The reception signal may include information on the transmission signal that is the original signal of the reception signal and transmitted by first radio 100. The information on the transmission signal that is the original signal of the reception signal need not be included in the reception signal and may be transmitted from first radio 100 to sensing device 200 using a different means.

Receiver 220 converts high-frequency signals received by the N reception antenna elements into low-frequency signals that can be signal processed. Receiver 220 then performs demodulation on OFDM signals and demodulates the OFDM signals into S subcarrier signals. The S subcarrier signals are also referred to as S IQ symbols. The S subcarrier signals are low-frequency signals.

Receiver 220 also calculates, for each subcarrier, a plurality of complex transfer functions each representing propagation characteristics between a transmission antenna element and a reception antenna element, from the S subcarrier signals obtained from the reception signals measured in the first period. Receiver 220 may constantly continue measuring (or recording) the reception signals received by reception antenna 210, and continuously or regularly obtain S subcarrier signals. In other words, receiver 220 may obtain S subcarrier signals based on a reception signal received at each of different timings.

For each of N×M combinations that are combinations of each of M transmission antenna elements and each of N reception antenna elements, receiver 220 calculates, for each of the subcarriers to which the subcarrier signals correspond, a plurality of complex transfer functions, each of which represents propagation characteristics between a transmission antenna element and a reception antenna element in each combination, using the reception signals measured in the first period. It should be noted that the N×M combinations are all the obtainable one-to-one combinations between the M transmission antenna elements and the N reception antenna elements.

In the present embodiment, N×M×S combinations of complex transfer functions, each of which represents propagation characteristics between a transmission antenna element and a reception antenna element, are calculated for each of the S subcarrier signals using S subcarrier signals. A calculated complex transfer function matrix also includes reflected waves that did not arrive via living body 300, such as direct waves or reflected waves derived from a fixed object.

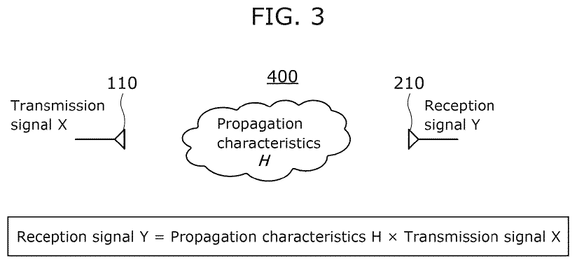

FIG. 3 is a diagram for illustrating the relationship of a transmission signal, a channel, and a reception signal.

Transmission signal X transmitted from transmission antenna 110 propagates through target space 400, received by reception antenna 210, and obtained as reception signal Y. Reception signal Y received by reception antenna 210 is a signal that has been changed from transmission signal X propagating through target space 400. For this reason, reception signal Y can be considered to be equal to a signal obtained by multiplying propagation characteristics H with transmission signal X in target space 400. Propagation characteristics H are represented by complex transfer functions of the aforementioned N×M×S combinations.

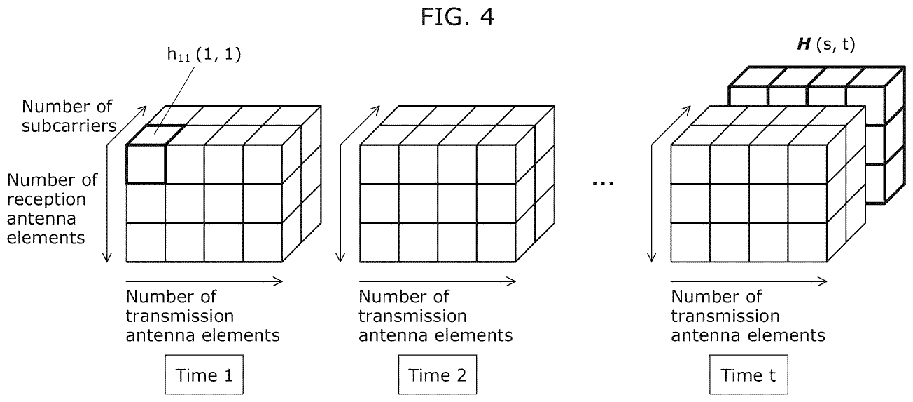

FIG. 4 is a diagram for illustrating propagation characteristics at each timing.

As described above, propagation characteristics H include a complex transfer function for each reception antenna element, for each transmission antenna element, and for each combination of three types of parameters for each subcarrier. In other words, a different complex transfer function is calculated for each of different reception antenna elements, a different complex transfer function is calculated for each of different transmission antenna elements, and a different complex transfer function is calculated for each of different subcarriers.

FIG. 4 illustrates images of propagation characteristics H represented by a combination of complex transfer functions when the number of reception antenna elements is 3, the number of transmission antenna elements is 4, and the number of carriers is 2. Propagation characteristics H in this case can be represented as a combination of 3×4×2 blocks. One block represents a single complex transfer function calculated using a single specific reception antenna element, a single specific transmission antenna element, and a single specific subcarrier. Thus, since propagation characteristics H can be represented as a combination of three types of parameters that are a reception antenna element, a transmission antenna element, and a subcarrier, propagation characteristics H can be represented three-dimensionally. Propagation characteristics H that is three-dimensionally represented is also calculated at each of timings.

There is a case where subcarriers and transmission antenna elements are fixed and a plurality of complex transfer functions of different reception antenna elements are represented as a plurality of complex transfer functions that are different in a reception antenna element direction. Similarly, there is a case where subcarriers and reception antenna elements are fixed and a plurality of complex transfer functions of different transmission antenna elements are represented as a plurality of complex transfer functions that are different in a transmission antenna element direction. Similarly, there is a case where reception antenna elements and transmission antenna elements are fixed and a plurality of complex transfer functions of different subcarriers are represented as a plurality of complex transfer functions that are different in a subcarrier direction. Thus, in propagation characteristics H that are three-dimensionally represented, each dimensional direction may be represented as a reception antenna element direction, a transmission antenna element direction, or a subcarrier direction, using names related to the three types of parameters.

For example, if rows in a matrix representing propagation characteristics H are assigned to reception antenna elements and columns in the matrix are assigned to transmission antenna elements among blocks in three dimensions, propagation characteristics H that are different depending on each timing of obtaining a reception signal are also calculated for each subcarrier. In other words, in the present embodiment, propagation characteristics H(s,t) between M transmission antenna elements and N reception antenna elements for the s-th subcarrier in the period of measurement time t are represented by a complex transfer function matrix expressed by Equation 1, from S subcarrier signals transmitted from receiver 220.

$$[ Math . 1 ]$$

$$H ( s , t ) = ( \begin{matrix}{h}_{11} ( s , t ) & ⋯ & {h}_{1 M} ( s , t ) \\ ⋮ & ⋱ & ⋮ \\ {h}_{N 1} ( s , t ) & ⋯ & {h}_{NM} ( s , t )\end{matrix} ) \qquad Equation 1$$

Obtainer 230 obtains radio information including propagation characteristics H calculated by receiver 220. Propagation characteristics H are one example of channel state information (CSI). Obtainer 230 obtains radio information items over a given period. In other words, obtainer 230 obtains a radio information item at each of timings over the given period. The radio information items obtained by obtainer 230 may be stored in storage 260. The radio information items include a plurality of propagation characteristics H generated based on reception signals obtained at continuous timings.

Determiner 240 determines whether first radio 100 is stationary based on radio information. Specifically, determiner 240 calculates an evaluation value based on index values that are based on CSI items included in radio information items stored in storage 260. An evaluation value is a value for evaluating variation among the index values. An evaluation value shows, for example, that the variation degree of the index values increases as the evaluation value increases. Determiner 240 then determines whether first radio 100 that is a movable radio is stationary, using the calculated evaluation value. The index values respectively correspond to the CSI items. In other words, the index values respectively correspond to reception signals obtained at different timings. Index values indicate the transition of the reception signals in chronological order.

Here, each of the index values is an index value in a specific index of a CSI item, among the CSI items, corresponding to the index value. The specific index may be, for example, the absolute value (i.e., amplitude) of the CSI item. In this case, the index values indicate absolute values (amplitudes) respectively corresponding to the CSI items. A single index value indicating an absolute value is expressed by Equation 2.

$$[ Math . 2 ]$$

$${H}_{amp} ( s , t ) = ( \begin{matrix}\vert {h}_{11} ( s , t ) \vert & ⋯ & \vert {h}_{1 M} ( s , t ) \vert \\ ⋮ & ⋱ & ⋮ \\ \vert {h}_{N 1} ( s , t ) \vert & ⋯ & \vert {h}_{NM} ( s , t ) \vert\end{matrix} ) \qquad Equation 2$$

In this case, determiner 240 calculates variance in a time direction based on absolute values. Determiner 240 determines whether the maximum value of the variance exceeds a predetermined threshold. When the maximum value of the variance exceeds the predetermined threshold, determiner 240 determines that first radio 100 is moving. When the maximum value of the variance is the predetermined threshold or less, determiner 240 determines that first radio 100 is stationary.

The specific index may be the phase of CSI. In this case, the index values indicate phases respectively corresponding to CSI items. A single index value indicating a phase is expressed by Equation 3.

$$[ Math . 3 ]$$

$${H}_{phase} ( s , t ) = ( \begin{matrix}∠ {h}_{11} ( s , t ) & ⋯ & ∠ {h}_{1 M} ( s , t ) \\ ⋮ & ⋱ & ⋮ \\ ∠ {h}_{N 1} ( s , t ) & ⋯ & ∠ {h}_{NM} ( s , t )\end{matrix} ) \qquad Equation 3$$

In this case, determiner 240 calculates variance in a time direction based on phases, and calculates the maximum value of the variance as an evaluation value. Determiner 240 determines whether the maximum value of the variance exceeds a predetermined threshold. When the maximum value of the variance exceeds the predetermined threshold, determiner 240 determines that first radio 100 is moving. When the maximum value of the variance is the predetermined threshold or less, determiner 240 determines that first radio 100 is stationary.

The specific index may be the correlation matrix of CSI. In this case, the index values indicate correlation matrices respectively corresponding to CSI items. A correlation matrix is calculated as follows.

Determiner 240 firstly vectorizes a complex transfer function matrix. A complex transfer function vector h_{vec}(s,t) obtained through the vectorization is expressed by Equation 4.

$$[ Math . 4 ]$$

$${h}_{vec} ( s , t ) = [ \begin{matrix}{h}_{11} ( s , t ) & {h}_{21} ( s , t ) & … & {h}_{NM} ( s , t )\end{matrix} ] \qquad Equation 4$$

Determiner 240 then calculates a correlation matrix R(s,t) based on the complex transfer function vector h_{vec}(s,t). The correlation matrix R(s,t) is expressed by Equation 5.

$$[ Math . 5 ]$$

$$R ( s , t ) = {h}_{vec} ( s , t ) {h}_{vec}^{H} ( s , t ) \qquad Equation 5$$

Here, [,]^{H} represents Hermitian transposition.

In addition, determiner 240 extracts a non-diagonal term from the correlation matrix R(s,t). Determiner 240 calculates a correlation vector r_{vec}(s,t) obtained by vectorizing an upper triangular matrix out of the non-diagonal term. A correlation vector r_{vec}(s,t) is calculated by Equation 6. A correlation vector is not limited to be calculated by vectorizing an upper triangular matrix, and may be calculated by vectorizing a lower triangular matrix out of the non-diagonal term.

$$[ Math . 6 ]$$

$${r}_{vec} ( s , t ) = {… [ \begin{matrix}{h}_{11} ( s , t ) {h}_{21}^{H} ( s , t ) & {h}_{11} ( s , t ) {h}_{31}^{H} ( s , t ) & … & {h}_{N ( M - 1 )} ( s , t ) {h}_{NM}^{H} ( s , t )\end{matrix} ]}^{T} \qquad Equation 6$$

Determiner 240 calculates variance in a time direction based on the correlation vector r_{vec}(s,t), and calculates the maximum value of the variance as an evaluation value. Determiner 240 determines whether the maximum value of the variance exceeds a predetermined threshold. When the maximum value of the variance exceeds the predetermined threshold, determiner 240 determines that first radio 100 is moving. When the maximum value of the variance is the predetermined threshold or less, determiner 240 determines that first radio 100 is stationary.

Determiner 240 calculates variance in a time direction based on index values, but may calculate covariance instead of variance. Covariance is calculated using, for example, any two of CSI, the amplitude of CSI, the phase of CSI, and a correlation matrix.

Although determiner 240 calculates, as an evaluation value, the maximum value of variance based on index values, determiner 240 is not limited to calculate the maximum value and may calculate at least one of a mean, a median, a mode, or a minimum value. Determiner 240 may calculate, as an evaluation value, at least one of the mean, median, mode, maximum value, or minimum value of covariances based on index values. Determiner 240 may calculate, as an evaluation value, a combination of at least two of the evaluation values indicated above. In the case of using a combination of two or more evaluation values, determiner 240 may calculate, as an evaluation value for determining whether a movable radio is stationary, the representative value (a mean, a median, a mode, a maximum value, or a minimum value) of two or more evaluation values.

Determiner 240 need not calculate an evaluation value for each component of propagation characteristics H that are three-dimensionally represented, and may calculate an evaluation value for a specific component.

When determiner 240 determines that first radio 100 is stationary, sensing portion 250 performs sensing of living body 300 in target space 400 using CSI included in radio information. Sensing portion 250 may detect the position of living body 300 in target space 400, identify the orientation of living body 300, determine whether living body 300 is present in target space 400, using CSI items, identify living body 300, or identify the movement of living body 300 based on CSI registered in advance for each living body 300. In the specification of the position of living body 300 in target space 400, sensing portion 250 may calculate the total distance of the distance between first radio 100 and living body 300 and the distance between second radio 201 and living body 300, or identify the direction (angle) of living body 300 relative to first radio 100, or identify the direction (angle) of living body 300 relative to second radio 201.

### [Operation]

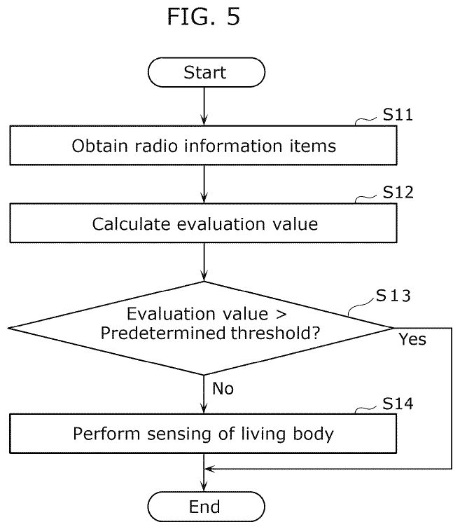

Next, the operation of sensing device 200 according to Embodiment 1 will be described. FIG. 5 is a flowchart illustrating one example of a sensing method to be performed by the sensing device according to Embodiment 1.

First, sensing device 200 obtains radio information items in chronological order (S11).

Subsequently, sensing device 200 calculates an evaluation value based on CSI items in chronological order included in the radio information items in chronological order (S12).

Sensing device 200 then determines whether the calculated evaluation value is greater than a predetermined threshold (S13).

When the calculated evaluation value is greater than the predetermined threshold (Yes in S13), since sensing device 200 can determine that first radio 100 is moving, sensing device 200 ends the process. In other words, when the calculated evaluation value is greater than the predetermined threshold, sensing device 200 does not perform sensing.

When the calculated evaluation value is the predetermined threshold or less (No in S13), since sensing device 200 can determine that first radio 100 is stationary, sensing device 200 performs sensing of living body 300 (S14).

Sensing device 200 may regularly repeat the processes from steps S11 to S14 shown in FIG. 5 or execute the processes when a predetermined condition is satisfied. The predetermined condition is, for example, arrival of a time specified in advance or reception of information specified in advance.

### Advantageous Effects, Etc.

Sensing device 200 according to the present embodiment includes obtainer 230, determiner 240, and sensing portion 250. Obtainer 230 obtains a radio information item obtained by at least one of: first radio 100 disposed in target space 400 and capable of at least wireless transmission; or second radio 201 disposed in target space 400 and capable of at least wireless reception. Determiner 240 determines, based on the radio information item, whether first radio 100 is stationary. Sensing portion 250 performs sensing of living body 300 in target space 400 using a channel state information (CSI) item when determiner 240 determines that first radio 100 is stationary, where the CSI item is included in the radio information item and received from first radio 100 by second radio 201.

According to this, since sensing is performed in target space 400 using CSI when first radio 100 that is movable is stationary, there is no need to take an influence caused by the movement of first radio 100 into consideration, and therefore, sensing of living body 300 can be accurately performed.

Sensing device 200 according to the present embodiment further includes storage 260. Storage 260 stores radio information items obtained over a given period. Determiner 240 determines whether first radio 100 is stationary, using an evaluation value calculated from index values based on CSI items included in the radio information items. Each of the index values is an index value of a specific index of a CSI item, among the CSI items, corresponding to the index value.

According to this, whether a movable radio is stationary is determined based on CSI items stored over a given period, even a radio without a sensor capable of detecting that the movable radio is moving can determine whether the movable radio is stationary.

### Embodiment 2

Embodiment 2 describes a method of determining whether wireless equipment is stationary, and sensing a living body when the wireless equipment is stationary in the case of employing a single-input single-output (SISO) method in which the number of transmission antennas and the number of reception antennas are both one.

### [Configuration]

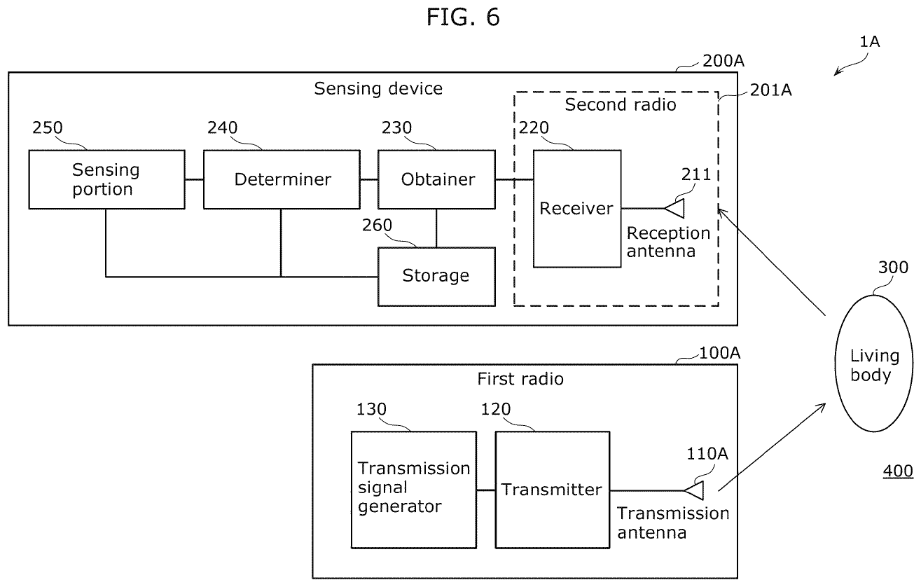

FIG. 6 is a diagram illustrating one example of the configuration of a sensing system according to Embodiment 2.

Sensing system 1A includes first radio 100A and sensing device 200A.

First radio 100A includes transmission antenna 110A, transmitter 120, and transmission signal generator 130.

Transmission antenna 110A includes a single transmission antenna element. The single transmission antenna element transmits a multicarrier signal (transmission wave) generated by transmitter 120 to be described later.

Transmission signal generator 130 generates a multicarrier signal obtained by modulating subcarrier signals. Specifically, transmission signal generator 130 generates subcarrier signals corresponding to subcarriers in mutually different frequency bands, and generates a multicarrier signal by multiplexing the generated subcarrier signals. The present embodiment illustrates an example that transmission signal generator 130 generates, as a multicarrier signal, an OFDM signal that has high frequency band utilization efficiency and includes S subcarriers. However, transmission signal generator 130 is not limited to generate an OFDM signal including subcarriers that are each orthogonal, and may generate other multicarrier signal such as a simple frequency division multiplexing (FDM) signal as long as the multicarrier signal is obtained through multicarrier modulation.

A signal generated by transmission signal generator 130 may be commonly used with a signal for use in communication.

Transmitter 120 additionally performs an appropriate process on a signal generated by transmission signal generator 130, and generates a transmission wave. The process performed here may include, for example, up-conversion of converting a signal from the frequency band of intermediate frequency (IF) to the frequency band of radio frequency (RF) and amplification of amplifying a signal to an appropriate transmission level. Transmitter 120 outputs a processed multicarrier signal to transmission antenna 110A to cause transmission antenna 110A to transmit the multicarrier signal. With this, the multicarrier signal is transmitted from the single transmission antenna element included in transmission antenna 110A.

Sensing device 200A includes reception antenna 210A, receiver 220, obtainer 230, determiner 240, sensing portion 250, and storage 260. Among these, reception antenna 210A and receiver 220 function as second radio 201A. In other words, it can be said that sensing device 200A includes second radio 201A in the present embodiment.

Reception antenna 210A includes a single reception antenna element. The single reception antenna element receives a signal (reception signal) transmitted from the single transmission antenna element and reflected by living body 300.

Receiver 220 measures, in a first period equivalent to a cycle derived from the activity of living body 300, a reception signal that is received by the single reception antenna element and includes a reflected signal obtained as a result of living body 300 reflecting or scattering a multicarrier signal transmitted from the single transmission antenna element. The cycle derived from the activity of living body 300 is a cycle derived from a living body (a biological variable cycle), and is a time that is at least a half of any one of the breathing cycle, the heartbeat cycle, or the body movement cycle of living body 300.

Receiver 220 converts a high-frequency signal received by the single reception antenna element into a low-frequency signal that can be signal processed. Receiver 220 then performs demodulation on an OFDM signal and demodulates the OFDM signal into S subcarrier signals. The S subcarrier signals are also referred to as S IQ symbols. The S subcarrier signals are low-frequency signals.

Receiver 220 also calculates, for each subcarrier, a plurality of complex transfer functions each representing propagation characteristics between a transmission antenna element and a reception antenna element, from the S subcarrier signals obtained from the reception signals measured in the first period. Receiver 220 may constantly continue the measuring (or recording) the reception signals received by reception antenna 210A, and continuously or regularly obtain S subcarrier signals. In other words, receiver 220 may obtain S subcarrier signals based on a reception signal received at each of different timings.

Receiver 220 calculates a plurality of complex transfer functions each representing propagation characteristics between a transmission antennal element and a reception antenna element for each of subcarriers to which the subcarrier signals respectively correspond.

In the present embodiment, S combinations of complex transfer functions, each of which represents propagation characteristics between a transmission antenna element and a reception antenna element, are calculated for each of the S subcarrier signals using S subcarrier signals. A calculated complex transfer function matrix includes also reflected waves that did not arrive via living body 300, such as direct waves or reflected waves derived from a fixed object.

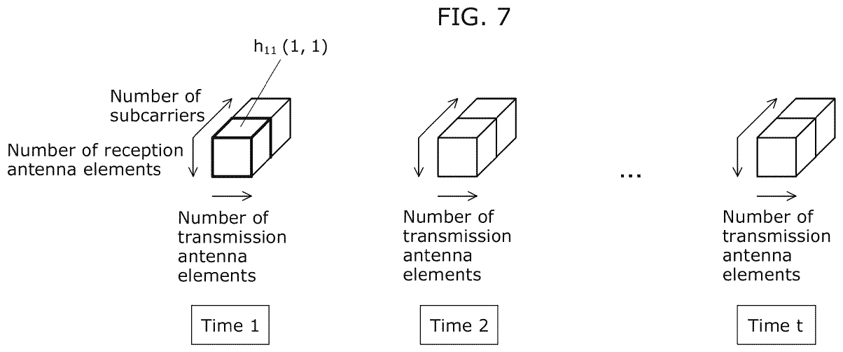

FIG. 7 is a diagram for illustrating propagation characteristics at each timing.

As described above, propagation characteristics H include a complex transfer function for one type of parameter for each subcarrier. In other words, a different complex transfer function is calculated for each of different subcarriers.

FIG. 7 illustrates images of propagation characteristics h(t) represented by a combination of complex transfer functions when the number of reception antenna elements is 1, the number of transmission antenna elements is 1, and the number of subcarriers is 2. Propagation characteristics h(t) in this case can be represented as a combination of 1×1×2 blocks. One block represents a single complex transfer function calculated using a single reception antenna element, a single transmission antenna element, and a single specific subcarrier. Thus, since propagation characteristics H are represented by one type of parameter that is a subcarrier, propagation characteristics h(t) can be represented by a one-dimensional vector. Propagation characteristics h(t) are calculated at each of timings.

In other words, in the present embodiment, propagation characteristics h(t) between a single transmission antenna element and a single reception antenna element in the period of measurement time t are represented by a complex transfer function vector expressed by Equation 7, from S subcarrier signals transmitted from transmitter 120.

$$[ Math . 7 ]$$

$$h ( t ) = [ \begin{matrix}{h}_{1} ( t ) & {h}_{2} ( t ) & … & {h}_{S} ( t )\end{matrix} ] \qquad Equation 7$$

Obtainer 230 obtains radio information including propagation characteristics h(t) calculated by receiver 220. Propagation characteristics H are one example of channel state information (CSI). Obtainer 230 obtains radio information items over a given period. In other words, obtainer 230 obtains a radio information item at each of timings over the given period. The radio information items obtained by obtainer 230 may be stored in storage 260. The radio information items include a plurality of propagation characteristics H generated based on reception signals obtained at continuous timings.

Determiner 240 determines whether first radio 100A is stationary based on radio information. Specifically, determiner 240 calculates an evaluation value based on index values that are based on CSI items included in radio information items stored in storage 260. An evaluation value is a value for evaluating variation among the index values. An evaluation value shows, for example, that the variation degree of the index values increases as an evaluation value increases. Determiner 240 then determines whether first radio 100A that is a movable radio is stationary, using the calculated evaluation value. The index values respectively correspond to the CSI items. In other words, the index values respectively correspond to reception signals obtained at different timings. The index values indicate the transition of the reception signals in chronological order.

Here, each of the index values is an index value in a specific index of a CSI item, among the CSI items, corresponding to the index value. The specific index may be, for example, the absolute value (i.e., amplitude) of the CSI item. In this case, the index values indicate absolute values (amplitudes) respectively corresponding to the CSI items. A single index value indicating an absolute value is expressed by Equation 8.

$$[ Math . 8 ]$$

$${h}_{amp} ( t ) = [ \begin{matrix}\vert {h}_{1} ( t ) \vert & \vert {h}_{2} ( t ) \vert & … & \vert {h}_{S} ( t ) \vert\end{matrix} ] \qquad Equation 8$$

In this case, determiner 240 calculates variance in a time direction based on the absolute values. Determiner 240 determines whether the maximum value of the variance exceeds a predetermined threshold. When the maximum value of the variance exceeds the predetermined threshold, determiner 240 determines that first radio 100A is moving. When the maximum value of the variance is the predetermined threshold or less, determiner 240 determines that first radio 100A is stationary.

The specific index may be the phase of CSI. In this case, the index values indicate phases respectively corresponding to CSI items. A single index value indicating a phase is expressed by Equation 9.

$$[ Math . 9 ]$$

$${h}_{phase} ( t ) = [ \begin{matrix}∠ {h}_{1} ( t ) & ∠ {h}_{2} ( t ) & … & ∠ {h}_{S} ( t )\end{matrix} ] \qquad Equation 9$$

In this case, determiner 240 calculates variance in a time direction based on phases, and calculates the maximum value of the variance as an evaluation value. Determiner 240 determines whether the maximum value of the variance exceeds a predetermined threshold. When the maximum value of the variance exceeds the predetermined threshold, determiner 240 determines that first radio 100A is moving. When the maximum value of the variance is the predetermined threshold or less, determiner 240 determines that first radio 100A is stationary.

The specific index may be the correlation matrix of CSI. In this case, the index values indicate correlation matrices respectively corresponding to the CSI items. A correlation matrix is calculated as follows.

Determiner 240 firstly calculates a correlation matrix R(t) based on a complex transfer function vector h(t). The correlation matrix R(t) is expressed by Equation 10.

$$[ Math . 10 ]$$

$$R ( t ) = h ( t ) {h}^{H} ( t ) \qquad Equation 10$$

Here, [,]^{H} represents Hermitian transposition.

In addition, determiner 240 extracts a non-diagonal term from the correlation matrix R(t). Determiner 240 calculates a correlation vector r_{vec}(t) obtained by vectorizing an upper triangular matrix out of the non-diagonal term. A correlation vector is not limited to be calculated by vectorizing an upper triangular matrix, and may be calculated by vectorizing a lower triangular matrix out of the non-diagonal term.

Determiner 240 calculates variance in a time direction based on correlation vector r_{vec}(t), and calculates the maximum value of the variance as an evaluation value. Determiner 240 determines whether the maximum value of the variance exceeds a predetermined threshold. When the maximum value of the variance exceeds the predetermined threshold, determiner 240 determines that first radio 100A is moving. When the maximum value of the variance is the predetermined threshold or less, determiner 240 determines that first radio 100A is stationary.

Determiner 240 calculates variance in a time direction based on index values, but may calculate covariance instead of variance. Covariance is calculated using, for example, any two of CSI, the amplitude of CSI, the phase of CSI, and a correlation matrix.

Determiner 240 calculates, as an evaluation value, the maximum value of variance based on index values, but may calculate at least one of a mean, a median, a mode, or a minimum value. Determiner 240 may calculate, as an evaluation value, at least one of the mean, median, mode, maximum value, or minimum value of covariances based on index values. Determiner 240 may calculate, as an evaluation value, a combination of at least two of the evaluation values indicated above. In the case of using a combination of two or more evaluation values, determiner 240 may calculate, as an evaluation value for determining whether a movable radio is stationary, the representative value (a mean, a median, a mode, a maximum value, or a minimum value) of two or more evaluation values.

Determiner 240 need not calculate an evaluation value for each component of propagation characteristics H that are three-dimensionally represented, and may calculate an evaluation value for a specific component.

When determiner 240 determines that first radio 100A is stationary, sensing portion 250 performs sensing of living body 300 in target space 400 using CSI included in radio information. Sensing portion 250 may detect the position of living body 300 in target space 400, identify the orientation of living body 300, identify living body 300 based on CSI registered in advance for each living body 300, or identify the movement of living body 300.

Since the operation of sensing device 200A can be described in the same way as the operation of sensing device 200, description is omitted.

### Variation 1

In the above embodiment, sensing device 200, 200A may be configured separately from second radio 201, 201A. In this case, sensing device 200, 200A may obtain radio information including propagation characteristics H calculated based on a reception signal received by second radio 201, 201A by communicating with second radio 201, 201A.

### Variation 2

In the above embodiment, second radio 201, 201A is described as a fixed router, but may be configured by a movable device, as is the case of first radio 100, 100A. Even in this case, sensing device 200, 200A can determine whether first radio 100, 100A and second radio 201, 201A are both stationary by determining whether an evaluation value is greater than a predetermined threshold, as described in the embodiment. In other words, when the evaluation value is greater than the predetermined threshold, it is determined that either first radio 100, 100A or second radio 201, 201A is moving. When the evaluation value is the predetermined threshold or less, it is determined that first radio 100, 100A and second radio 201, 201A are both stationary.

### Variation 3

The above embodiment describes that whether first radio 100, 100A and second radio 201, 201A are both stationary is determined based on CSI, but the present disclosure is not limited to this example. For example, a case where first radio 100, 100A is movable and second radio 201, 201A is fixed is considered. In this case, first radio 100, 100A includes a sensor for detecting the movement of first radio 100, 100A, and sensing device 200 may obtain a result of the detection by the sensor from first radio 100, 100A as radio information. Sensing device 200 may determine whether first radio 100, 100A is moving or stationary based on the detection result. The sensor may be, for example, an acceleration sensor, an angular rate sensor, or a global positioning system (GPS) sensor. When second radio 201, 201A is also movable, second radio 201, 201A, like first radio 100, 100A, also has a sensor for detecting the movement of second radio 201, 201A, and sensing device 200 may determine whether second radio 201, 201A is moving or stationary based on a detection result of the sensor. This also applies to a case where first radio 100, 100A is fixed and second radio 201, 201A is movable. Thus, sensing device 200 may determine whether first radio 100, 100A and second radio 201, 201A are both stationary based on the detection result of a sensor for detecting movement which is obtained from each and every one of movable radios.

According to this, since whether a movable radio is stationary is determined based on sensing information obtained from at least one of an acceleration sensor, an angular rate sensor, or a GPS sensor, it is possible to accurately determine whether the movable radio is stationary.

### Variation 4

In the above embodiment, a movable radio holds an identifier for identifying the movable radio, and the identifier may be included in a transmission signal and transmitted. This enables sensing device 200 to identify a movable radio.

### Variation 5

The above embodiment describes that first radio 100, 100A is separate from sensing device 200, 200A including second radio 201, 201A, but the present disclosure is not limited to this example. First radio 100, 100A may be integrated with sensing device 200, 200A. Even in this case, sensing device 200, 200A can determine whether first radio 100, 100A and second radio 201, 201A that are integrated are stationary using the same method as described in the above embodiment.

### Variation 6

The aforementioned Embodiment 1 describes that a complex transfer function matrix is vectorized, but the vectorization need not be performed. The aforementioned Embodiment 1 also describes that a matrix including elements corresponding to a transmission antenna element and a reception antenna element for each subcarrier, but a three-dimensional matrix in a transmission antenna element direction, a reception antenna element direction, and a subcarrier direction may be vectorized.

### Others

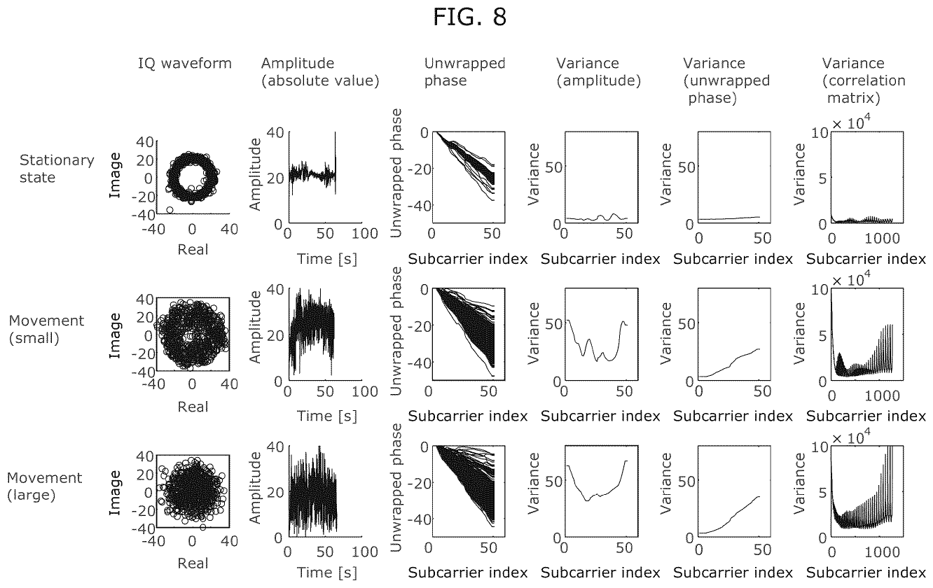

FIG. 8 is a diagram illustrating the experiment results of evaluation values for estimating whether a radio is stationary based on CSI.

FIG. 8 is a diagram illustrating IQ waveform, amplitude, unwrapped phase, amplitude variance, unwrapped phase variance, and correlation matrix variance that are obtained from CSI in a state in which a movable radio is stationary, in a state in which the movable radio is moving in a short distance, or in a state in which the movable radio is moving in a long distance. As illustrated in FIG. 8, a change is small in a stationary state and the change increases as the movement increases. Thus, it is shown that whether a movable radio is moving or stationary can be determined by calculating amplitude, a phase, a correlation matrix, and variance thereof as evaluation values.

In the embodiments and the variations thereof, each element may be configured using dedicated hardware or may be implemented by executing a software program suitable for the element. Each element may be implemented by a program execution unit such as a CPU or a processor reading and executing a software program recorded on a recording medium such as a hard disk or a semiconductor memory.

The present disclosure can not only be realized as a sensing device including such characteristic elements, but can also be realized as a sensing method with steps corresponding to the characteristic elements included in the sensing device. The present disclosure can also be realized as a computer program that causes a computer to execute each of the characteristic steps included in such a method. It goes without saying that such a computer program can be distributed via a non-transitory computer-readable recording medium such as a CD-ROM or via a communication network such as the Internet.

Forms obtained by various modifications to the above embodiments which may be conceived by those skilled in the art, as well as forms resulting from any combination of elements or functions in the embodiments, so long as they do not depart from the essence of the present invention, are also included within the scope of the present invention.

### INDUSTRIAL APPLICABILITY

The present disclosure can be utilized for sensing devices and sensing methods that estimate the distance or position of a living body by using radio signals, and particularly, can be used for measuring instruments that measure the distance or position of a living body and a living body including a machine, home appliances that perform control according to the distance or position of a living body, and surveillance device that detect intrusion of a living body.

1. A sensing device comprising:
an obtainer that obtains a radio information item obtained by at least one of: a first radio disposed in a target space and capable of at least wireless transmission; or a second radio disposed in the target space and capable of at least wireless reception;
a determiner that determines, based on the radio information item, whether a movable radio out of the first radio and the second radio is stationary; and
a sensing portion that (i) performs sensing of a living body in the target space using a channel state information (CSI) item when the determiner determines that the movable radio is stationary, the CSI item being included in the radio information item and received from the first radio by the second radio, and (ii) does not perform the sensing when the determiner determines that the movable radio is moving.

2. The sensing device according to claim 1, wherein
the radio information item also includes sensing information obtained by at least one of an acceleration sensor, an angular rate sensor, or a global positioning system (GPS) sensor included in the movable radio, and
the determiner determines whether the movable radio is stationary based on the sensing information.

3. The sensing device according to claim 1, further comprising:
a storage that stores radio information items obtained over a given period, the radio information items each being the radio information item, wherein
the determiner determines whether the movable radio is stationary, using an evaluation value calculated from index values based on CSI items included in the radio information items, and
each of the index values is an index value of a specific index of a CSI item, among the CSI items, corresponding to the index value.

4. The sensing device according to claim 3, wherein
the specific index includes an absolute value of the CSI item.

5. The sensing device according to claim 3, wherein
the specific index includes a phase of the CSI item.

6. The sensing device according to claim 3, wherein
the specific index includes a correlation matrix of the CSI item.

7. The sensing device according to claim 3, wherein
the evaluation value includes variance or covariance of the index values.

8. The sensing device according to claim 3, wherein
the evaluation value includes (i) at least one of a mean, a median, a mode, a maximum value, or a minimum value of the index values, or (ii) at least one of a mean, a median, a mode, a maximum value, or a minimum value of variance or covariance of the index values.

9. A sensing method to be executed by a sensing device, the sensing method comprising:
obtaining a radio information item obtained by at least one of: a first radio disposed in a target space and capable of at least wireless transmission; or a second radio disposed in the target space and capable of at least wireless reception;
determining, based on the radio information item, whether a movable radio out of the first radio and the second radio is stationary; and
performing sensing of a living body in the target space using a channel state information (CSI) item when it is determined that the movable radio is stationary in the determining, the CSI item being included in the radio information item and received from the first radio by the second radio, and not performing the sensing when it is determined that the movable radio is moving in the determining.

10. A non-transitory computer-readable recording medium for use in a computer, the recording medium having recorded thereon a computer program for causing the computer to execute the sensing method according to claim 9.
